(19) United States
(12) Patent Application Publication
(10) Pub. No.: US 2022/0069388 A1
(43) Pub. Date: Mar. 3, 2022

(54) ENERGY SYSTEM AND METHOD FOR PRESSURE ADJUSTMENT IN AN ENERGY SYSTEM

(71) Applicant: HPS Home Power Solutions GmbH, Berlin (DE)

(72) Inventors: Andreas Hierl, Berlin (DE); Hendrik Leverenz, Berlin (DE)

(21) Appl. No.: 17/415,945

(22) PCT Filed: Dec. 18, 2019
(86) PCT No.: PCT/EP2019/086000

§ 371 Date: Jun. 18, 2021

(30) Foreign Application Priority Data
Dec. 20, 2018 (DE) 10 2018 133 198.3

(51) Int. Cl. H01M 16/00; C25B 15/08; H01M 8/04082; H01M 8/0656

(52) U.S. Cl. CPC H01M 16/003; C25B 15/08; H01M 2250/10; H01M 8/0656; H01M 8/04201

(57) ABSTRACT

The invention relates to an energy system (10) and a method for adjusting the line pressure in an energy system (10). The energy system (10) comprises a first energy source unit (21), a first energy sink unit (22), a second energy source unit (31) and a connection line unit (40), via which the first energy source unit (21) is connected to the second energy source unit (31) and the second energy source unit (31) is connected to the first energy sink unit (21). In order to reduce, as far as possible, the number of components in the energy system (10), preferably also the number of line sections of the connection line unit (40) required for different operating modes of the energy system (10) with different pressure levels, according to the invention, at least individual sections of the connection line unit (40) are designed as bidirectional line sections (40a to 40e) and the connection line unit (40) is connected to a pressure adjustment unit (50), which is provided in such a way that it can set a direction-dependent pressure level in the bidirectional line sections (40a to 40e) of the connection line unit (40).

### REFERENCE TO PENDING PRIOR PATENT APPLICATIONS

This patent application claims benefit of International (PCT) Patent Application No. PCT/EP2019/086000, filed 18 Dec. 2019 by HPS Home Power Solutions GmbH for ENERGY SYSTEM AND METHOD FOR PRESSURE ADJUSTMENT IN AN ENERGY SYSTEM, which in turn claims benefit of German Patent Application No. DE 10 2018 133 198.3, filed 20 Dec. 2018.

The two (2) above-identified patent applications are hereby incorporated herein by reference.

### FIELD OF THE INVENTION

The present invention first relates to an energy system according to the preamble of independent claim 1. The invention further relates to a method for pressure adaption in an energy system according to the preamble of independent claim 10.

### BACKGROUND OF THE INVENTION

Energy systems of the generic type are already known in many ways in the prior art. Such systems are commonly used to generate and provide energy for a wide variety of fields of application.

In a known type of such energy systems, energy is generated in a first energy source. The energy generated may be, for example, hydrogen H2. The hydrogen is produced, for example, by means of electrolysis and it is stored in a second energy source device, which is, for example, a storage device. This is, for example, a first mode of operation of the energy system. During the operation of the energy system, the hydrogen is withdrawn from the storage device and consumed in a first energy sink device. This is, for example, a second mode of operation of the energy system. Such a first energy sink device is, for example, a fuel cell device. Usually, the aforementioned components of the energy system are spatially separated from one another and are connected to one another via a connecting line device. Both of the aforementioned modes of operation usually require a different pressure level. While, for example, pressures of 20 to 60 bar prevail in the first mode of operation with the electrolysis, for the operation of the fuel cell device in the second mode of operation, pressures of, for example, less than 20 bar are required.

For this reason, in known energy systems, the different operating modes are usually carried out separated from one another in line sections of the connecting line device being separated from another. Via first line sections of the connecting line device, which serve solely for storing, the generated hydrogen is transported from the first energy source device to the second energy source device with the first pressure present in the process. Via second line sections of the connecting line device, which serve solely for withdrawal, the hydrogen stored in the second energy source device is transported with the second pressure required for this purpose to the first energy sink device and consumed there.

Such a known energy system is disclosed, for example, in DE 103 07 112 A1. The disadvantage of this known energy system is that, because of the different pressures, the connecting line device has different line sections, which in each case are used only in the first mode of operation or in the second mode of operation of the energy system. This is complicated in terms of construction and is also expensive because of the special requirements of the lines. In addition, there is the problem that, the more line sections are present, even more leakages in the connecting line device can occur. Furthermore, the number of required components for the energy system is high, which makes the energy system additionally cost-intensive.

There is therefore a need to reduce the number of components required in the energy system.

In principle, it has already become known for this purpose to use bidirectional lines which can be flowed through selectively in different directions. However, in such solutions known in the prior art, the bidirectional lines have only one pressure level. This means that different operating pressures are regulated only after the bidirectional line, for example via separate pressure regulators or the like.

In another technical field, namely the storage and transport of natural gas, it is already disclosed in EP 3 091 176 A1 that bidirectional operation of gas transport lines in gas transport networks using a rotary flow-machine is possible, as a result of which the number of required line strands can be reduced. However, this solution cannot easily be transferred to the energy system of the type mentioned at the beginning.

### SUMMARY OF THE INVENTION

The object of the present invention is therefore to further develop an energy system of the type mentioned at the beginning in such a way that the disadvantages as mentioned can be avoided. In particular, the number of components of the energy system, preferably also the number of line sections required for the different modes of operation, is as well to be reduced as possible. Further a correspondingly improved method for adapting the pressure in an energy system is to be provided.

According to the invention, this object is achieved by the energy system comprising the features according to the independent claim 1, which represents the first aspect of the invention, and by the method comprising the features according to the independent claim 10, which represents the second aspect of the invention. Further features and details of the invention become apparent from the dependent claims, from the description and from the drawings. In this context, features and details which are disclosed in connection with the first aspect of the invention apply to their full extent also in connection with the second aspect of the invention, and vice versa, so that with regard to the disclosure of these two aspects of the invention, full reference is always made to the other aspect of the invention respectively.

It is the basic idea of the present invention that a connecting line device comprising bidirectional line sections, in particular a bidirectional (H2)-purge line, having a direction-dependent pressure level is provided as well as a method for pressure adaptation.

When the operating modes are changed, for example from a higher line pressure to a lower line pressure, the pressure in the line must be reduced. This can be realized with the present invention, wherein as few new components as possible are required. Optimally, this switching between the individual operating modes takes place without losses, in particular without releasing H2.

A number of advantages can be realized with the present invention. Thus, the number of components required, for example lines, fittings, sensors, security elements, and the like can be reduced. A low-pressure level prevails in the sensitive areas. Losses, such as H2-losses, can also be avoided.

According to the first aspect of the invention, an energy system is provided which comprises the features of the independent claim 1.

The energy system is in particular an entity composed of a plurality of components, wherein the components are connected to one another to form a dedicated unit. In the present case, the energy system is a system for generating or providing energy, preferably electrical energy. Generally, the invention is not limited to certain types of energy systems. In the following, various preferred exemplary embodiments are described in this regard.

According to a preferred embodiment, the energy system is a house energy system. House energy systems are known in principle from the state of the art and are used to supply houses, for example low-energy houses, passive houses or zero-energy houses, with energy in the form of heat and in particular in the form of current, for example current from regenerative energy sources such as, for example, photovoltaic (PV) generators or small wind power plants. Such a house energy system provides the basis that the energy requirement of a house, in particular of a low-energy house, a passive house or a zero-energy house, can be completely covered from renewable energy sources both with regard to the current and heat requirement and thus consists of complete CO₂ freedom during operation. At least however, the electricity demand of a house can be covered almost completely from renewable energy sources, in particular by means of a PV generator and/or a small wind power plant, in the sense of seeking an increase in self-consumption.

Such a house energy system is described, for example, in patent applications WO 2017/089468 A1 and WO 2017/089469 A1 of the applicant, the disclosure of which being incorporated into the description of the present patent application.

According to a preferred embodiment, a house power system of the type mentioned comprises the following basic features:
a DC feed point, preferably designed for a nominal voltage of 48 volts, and/or an AC feed point, preferably designed for a voltage of 230 volts or 110 volts, wherein the DC feed point and/or the AC feed point, during operation, is connected at least temporarily to an electrical equipment having a consumption power,
a PV generator which is electrically connected at least temporarily to the DC feed point, in order to generate an electrical PV power,
a fuel cell unit which is electrically connected at least temporarily to the DC feed point or to the AC feed point in order to generate an electrical fuel cell power,
an electrolysis unit electrically connected to the DC feed point for generating hydrogen to be consumed by the fuel cell unit, wherein the electrolysis unit is supplied with an electrical electrolysis input power during operation,
a hydrogen tank, in particular as a long-term energy storing device, which is, at least temporarily, fluidically connected to the fuel cell unit and to the electrolysis unit and which is provided to store hydrogen to be generated by means of the electrolysis unit and to be consumed by the fuel cell unit,
a storage battery unit, in particular as a short-term energy storage device, which is electrically connected or to be connected to the DC feed point, such that an electrical PV power and an electrical fuel cell power can be stored in the storage battery unit, and an electrical electrolysis input power and a consumption power can be withdrawn from the storage battery unit; and
a control module for controlling the house power plant.

The system according to the invention initially comprises a first energy source device. The first energy source device is configured to generate or to provide an energy. An energy source device is generally distinguished in particular by the fact that more flows out than flows in. The generation or production of the energy can take place in various ways. For example, the first energy source device can be configured as an electrolysis device. According to a preferred embodiment, the first energy source device, in particular in the form of an electrolysis device, is configured to produce hydrogen H2. In the electrolysis, a chemical reaction is generally forced by means of electric current for the extraction or production of substances. However, the invention is not limited to this specific exemplary embodiment.

The energy system also comprises a first energy sink device. In particular, an energy sink device is generally characterized by the fact that more flows into it than flows out. According to a preferred embodiment, the first energy sink device is a fuel cell device. Fuel cell devices per se are familiar to the person skilled in the art. Generally speaking, fuel cells convert a supplied fuel, such as hydrogen, and an oxidant into electrical energy. However, the invention is not limited to this specific exemplary embodiment.

According to a further embodiment, the energy system comprises a second energy source device. This is preferably a storage device, in particular a high-pressure storage device, in which the energy generated in the first energy source device, for example hydrogen, is stored until it is used, for example in the first energy sink device, for example a fuel cell device. If the second energy source device is a high-pressure storage device, a storage with pressures up to 700 bar is preferred.

The energy system of the present invention comprises a connecting line device, via which the first energy source device is connected to the second energy source device and the second energy source device is connected to the first energy sink device.

According to a preferred embodiment, the energy system further comprises a second energy sink device which is connected via a valve device to the connecting line device. The valve device is, in particular, a shut-off valve, for example a solenoid valve, by means of which a volume flow can be shut off. A valve device as described in the context of the present invention is preferably a component which is arranged behind an energy source device. According to a preferred embodiment the second energy sink device is configured as a medium-pressure storage device, in particular for the intermediate storage of hydrogen. In particular, a storage with pressures between 20 and 60 bar is preferred in the second energy sink device. If such a second energy sink device is used, the energy generated in the first energy source device, for example hydrogen, is first transported to the second energy sink device and temporarily stored therein before from there a storage in the second energy source device, for example in a high-pressure storage device, takes place.

The connecting line device preferably comprises the entirety of the line sections present in the energy system. The connecting line device or the line sections thereof are preferably configured in the form of pipelines and/or hose lines. In this case, a line section preferably represents a section of the entire connecting line device. In the simplest case, a connecting line device comprises one single line section. However, it is preferred that the connecting line device comprises two or more line sections. Individual line sections can be configured as so-called unidirectional line sections, which means that a flow takes place in these line sections only in one direction. According to the invention, at least individual sections of the connecting line device are now configured as bidirectional line sections. A bidirectional line section is a line section which is used bidirectionally, that is in two directions. A bidirectional line section is distinguished by the fact that the latter is used reciprocally and that, during operation of the energy system, a flow takes place in both directions of the line section. The number of line sections required can thus be significantly reduced.

Coming back to the above-described embodiment with the two modes of operation of the energy system, the use of bidirectional line sections, when changing the operating modes, requires a pressure change, in particular a pressure reduction, for example from the first operating mode electrolysis with 20 to 60 bar to the second operating mode fuel cell operation at less than 20 bar.

For this reason, according to the invention, the connecting line device is connected to at least one pressure adaptation device. In general, the invention is not limited to certain types of pressure adjustment devices. In principle, the pressure adjustment device must be configured in such a way that it is capable of adjusting a direction-dependent pressure level in the bidirectional line sections of the connecting line device. The pressure adaption device consequently serves, in particular, to adjust the pressure being required in the line sections at the various modes of operation.

According to a preferred embodiment, the pressure adaptation device is configured as a device for pressure reduction in the bidirectional line sections of the connecting line device. This functionality of the pressure adaptation device is now be explained by way of example on the basis of the following example.

When hydrogen is produced with the energy system by means of electrolysis, which hydrogen is subsequently stored in a storage device before it is subsequently consumed in a fuel cell device in order to generate electric current, the hydrogen produced in the electrolysis device gets transported to the storage device in a first mode of operation of the energy system via line sections of the connecting line device in a first direction. In the second mode of operation of the energy system, in which the hydrogen is transported out of the storage device to the fuel cell device, these line sections can also get used, the transport then taking place in an opposite second direction to the first mode of operation. In the first mode of operation, pressures between 20 and 60 bar prevail in the bidirectional line sections, which pressures must be reduced to less than 20 bar by means of the pressure adaption device for the second mode of operation.

Some preferred exemplary embodiments are now described with regard to the pressure adaption device, wherein the invention is not limited to these specific embodiments. In principle, it is sufficient if one single pressure adaptation device is realized. Of course, embodiments are also conceivable in which two or more pressure adaptation devices are realized at the same time. In the case of a plurality of pressure adaptation devices, these can be formed either of the same type or differently. Combinations of different pressure adaptation devices are therefore also preferred.

According to a preferred embodiment, the pressure adaption device comprises a compressor device, which is arranged in the connecting line device and which is connected to a storage device, in particular to the second energy source device. According to an embodiment, the compressor device can be connected to a storage device dedicated to the pressure adaptation. According to another preferred embodiment, the compressor device is connected to the second energy source device. By means of the compressor device, a volume being present in the connecting line device, in particular in the bidirectional line sections of the connecting line device, gets stored into the second energy source device. As a result, the remaining volume in the connecting line device, in particular in the bidirectional line sections of the connecting line device, is reduced, as a result of which its pressure is reduced therein. In the case of hydrogen generation, the hydrogen generated in the first energy source means, which is present at a pressure of between 20 and 60 bar in the connecting line device, for example in the bidirectional line sections thereof, can get stored via the compressor device into the second energy source device, which is preferably a storage device, in particular a high-pressure storage device, or in the storage device described further above, specifically provided for this purpose. This is preferably carried out until the pressure in the connecting line device, in particular in the bidirectional line sections thereof, is only so high that the energy system can be operated in the second operating mode, that is to say at a pressure of less than 20 bar. Depending on the exemplary embodiment, the storage device, preferably the second energy source device, can likewise be a part of the pressure adaptation device.

For example, the compressor device can be an independent compressor device in the energy system, which is only used for the purpose of pressure adaption. However, in order to keep the number of components in the energy system as low as possible, the compressor device of the pressure adaption device is in particular at the same time also that compressor device, which is used for the storage of the energy generated by the first energy source device, for example the hydrogen. In the latter case, the pressure adaptation device is implemented by a functionality of a component of the energy system which, during operation of the energy system, also performs a different functionality. This also applies in particular when the second energy source device is assigned to the pressure adaptation device. The compressor device is preferably a piston compressor.

According to another preferred embodiment, the pressure adaptation device is configured as an additional expansion volume, which is connected to the connecting line device via a valve device. In this case, the additional expansion volume is preferably greater, in particular by a multiple greater than the volume of the connecting line device, in particular as the volume of the bidirectional line sections of the connecting line device. In the case of the additional expansion volume is thus an additional volume which, if necessary, can get connected to the connecting line device, in particular with to its bidirectional line sections. The additional expansion volume preferably has the pressure of the first energy sink device, for example the pressure of the fuel cell device. In the first mode of operation of the energy system, the additional expansion volume is separated from the connecting line device via the valve device, which is preferably a shut-off valve. If the operating pressure of the second mode of operation of the energy system is required, the volume can be connected via the valve device of the connecting line device. A mixed pressure/line pressure is set up after

$${p}_{L , new} = \frac{{p}_{L , old} \cdot {V}_{L} + {p}_{Vol} \cdot {V}_{Vol}}{( {V}_{L} + {V}_{Vol} )}$$

According to yet another embodiment, the energy system comprises a purging device which is provided in such a way that it is capable of purging the first energy source device and/or the first energy sink device. The purging device preferably comprises a storage chamber, which is also referred to as a purge chamber, and which, for example, can be provided as a bellows or a purge bellows respectively. According to this embodiment, the purging device, in particular the storage chamber thereof, functions as the pressure adaptation device, wherein the purging device, in particular the storage chamber, is connected to the connecting line device, in particular to the bidirectional line sections of the connecting line device, via a valve device, in particular a shut-off valve. In this exemplary embodiment, the line pressure is reduced successively, for example by discharging hydrogen via the purging device in a controlled manner. However, this embodiment does not provide a closed system and is accompanied by a loss of hydrogen.

According to another preferred embodiment of the energy system according to all embodiments, at least one check valve device is arranged in the connecting line device, wherein the check valve device in particular indicates one end of a bidirectional line section. A check valve device, as described in the context of the present patent application, is preferably a component which is arranged in front of an energy sink device. By means of the check valve device, the line section of the connecting line device connected thereto is closed in terms of flow in one direction, while the line section remains free of flow in the other direction, that is to say remains open. The check valve device makes it possible, in particular, that a volume being present in the connecting line device can flow from a bidirectional line section into a unidirectional line section, but cannot flow back from there.

According to a further embodiment, at least one pressure measuring device is assigned to the connecting line device in order to determine the pressure prevailing in the connecting line device, in particular in the bidirectional line sections thereof. The pressure measuring device can be configured, for example, as a pressure sensor. It can either measure the pressure directly or determine the pressure indirectly from other parameters. Pressure measuring devices are known per se. In particular, it is the function of the pressure measuring device to determine whether, in the event of a pressure adjustment by the pressure adaptation device, the, in particular lower, pressure required for the second mode of operation of the energy system, has been reached. In principle, one pressure measuring device is sufficient. However, several pressure measuring devices can be provided, which are then preferably distributed at different points in the energy system, in particular in the connecting line device thereof.

According to the second aspect of the invention, a method for pressure adaptation is provided which comprises the features of the independent claim 10.

The method is preferably carried out in an energy system according to the first aspect of the invention, so that with regard to the configuration of the method, in particular with regard to its procedure and mode of operation, in order to avoid repetitions at this point, full reference is also made to the statements relating to the first aspect of the invention.

The method serves to adapt the line pressure in a connecting line device of an energy system, in particular a house energy system, wherein the energy system comprises a first energy source device which is connected via the connecting line device to a second energy source device, and wherein the energy system comprises a first energy sink device, which is connected to the second energy source device via the connecting line device. According to the invention, the method is characterized by the following steps:

In a first mode of operation of the energy system, an energy provided by the first energy source device is transported at a first pressure via the connecting line device to the second energy source device and is stored there, wherein at least individual sections of the connecting line device are configured as bidirectional line sections. Thus, in the first mode of operation, the first pressure prevails in the connecting line device, in particular in the bidirectional line sections of the connecting line device. The first pressure is preferably in the range between 20 and 60 bar.

In at least one second mode of operation of the energy system, energy provided by the second energy source device is supplied with a second pressure, which is different from the first pressure, via the bidirectional line sections of the connecting line device to the first energy sink device. The second pressure is, in particular, the pressure at which the first energy sink device can be operated. Thus, in the second mode of operation, the second pressure prevails in the connecting line device, in particular in the bidirectional line sections of the connecting line device. The second pressure is preferably less than 20 bar.

Depending on the mode of operation of the energy system, a direction-dependent pressure level in the bidirectional line sections of the connecting line device is set by means of a pressure adaptation device, which is connected to the connecting line device.

According to a preferred development of the method, when changing from the first mode of operation of the energy system to the second mode of operation of the energy system, the line pressure prevailing in the first mode of operation in the form of the first pressure in the bidirectional line sections is reduced to the line pressure in the form of the second pressure prevailing in the second mode of operation by means the pressure adaptation device. This is achieved in particular in such a way that the volume being present at least in the bidirectional sections of the connecting line device is reduced by means of the pressure adaptation device to such an extent that the remaining volume is expanded to such an extent that it only has the second pressure.

If the energy system comprises a second energy sink device, which is connected to the connecting line device via a valve device, the method is preferably configured such that, in the first mode of operation of the energy system, the energy provided by the first energy source device with the first pressure is transported via the connecting line device to the second energy sink device and is intermediately stored there, and in that subsequently the energy intermediately stored in the second energy sink device is transported from there to the second energy source device and stored there.

Preferably, a compressor device is arranged in the connecting line device, so that in a preferred embodiment the method is characterized in that, in the first mode of operation of the energy system, energy which is provided by the first energy source device with the first pressure is transported via the connecting line device to the compressor device and is stored via said compressor device in the second energy source device.

According to a first preferred embodiment, the compressor device functions as a pressure adaptation device, wherein, depending on the mode of operation of the energy system, a direction-dependent pressure level is set in the bidirectional line sections of the connecting line device by means of the compressor device.

Preferably, in the event of a change from the first mode of operation of the energy system to the second mode of operation of the energy system, via the compressor device the line pressure prevailing in the first mode of operation in form of the first pressure in the bidirectional line sections is reduced to the line pressure prevailing in the second mode of operation in form of the second pressure in the bidirectional line sections, in that in particular volume being present in the connecting line device, is stored via the compressor device into the second energy source device until the second pressure is achieved in the bidirectional line sections of the connecting line device. This is achieved in particular in that the corresponding valve devices are adjusted in a suitable manner. If a second energy sink device in the form of an intermediary storage device is additionally used in the energy system, in this method step the second energy sink device is preferably disconnected from the volume in the connecting line device by shutting off the valve device, since otherwise the content of the second energy sink device would also have to be reduced to the second pressure as well.

Of course, the method can also be used in connection with the other embodiments described further above in connection with the system according to the invention, for example by means of pressure reduction by means of an additional expansion volume or by means of pressure reduction by means of a purging device, so that, with regard to such a method procedure, full reference is made to the corresponding statements at this point.

In principle, the present invention can be applied to all systems with a bidirectionally used line and a direction-dependent pressure, in particular to storage systems with separate source and sink, preferably to hydrogen storage systems.

### BRIEF DESCRIPTION OF THE DRAWINGS

The invention will now be explained in more detail with reference to an exemplary embodiment with reference to the accompanying drawings, wherein

FIG. 1 is a schematic view of an energy system according to the invention, in which the method according to the invention can be carried out;

FIG. 2 depicts the process of the method according to the invention, wherein a first mode of operation of the energy system is shown;

FIG. 3 depicts the process of the method according to the invention, wherein the transition between the first mode of operation of the energy system to a second mode of operation of the energy system is shown; and

FIG. 4 depicts the process of the method according to the invention, wherein the second mode of operation of the energy system is shown.

### DETAILED DESCRIPTION OF THE PREFERRED EMBODIMENTS

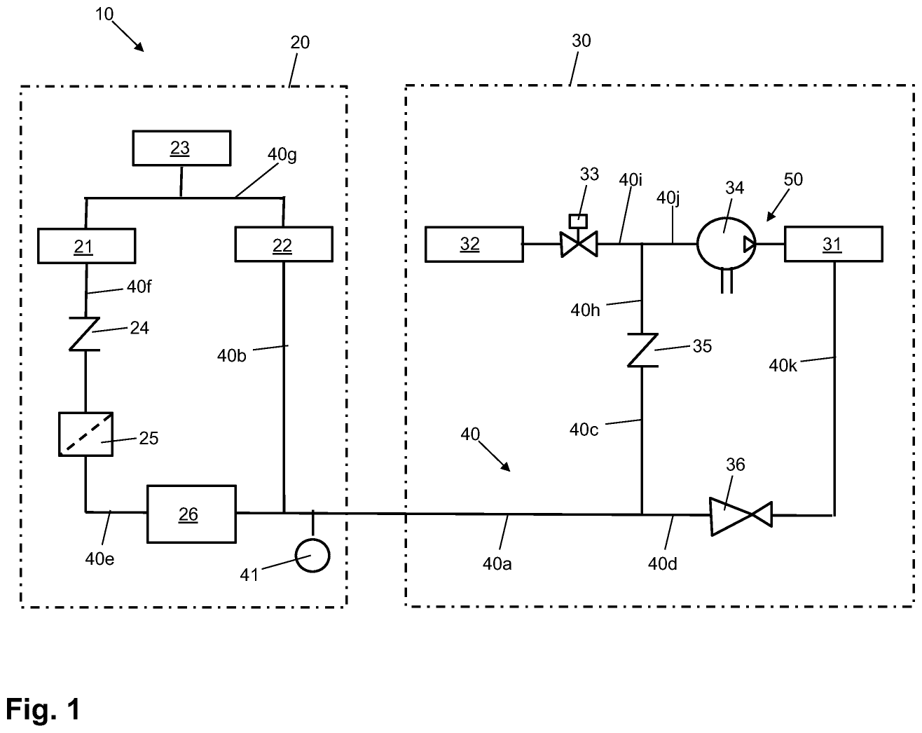

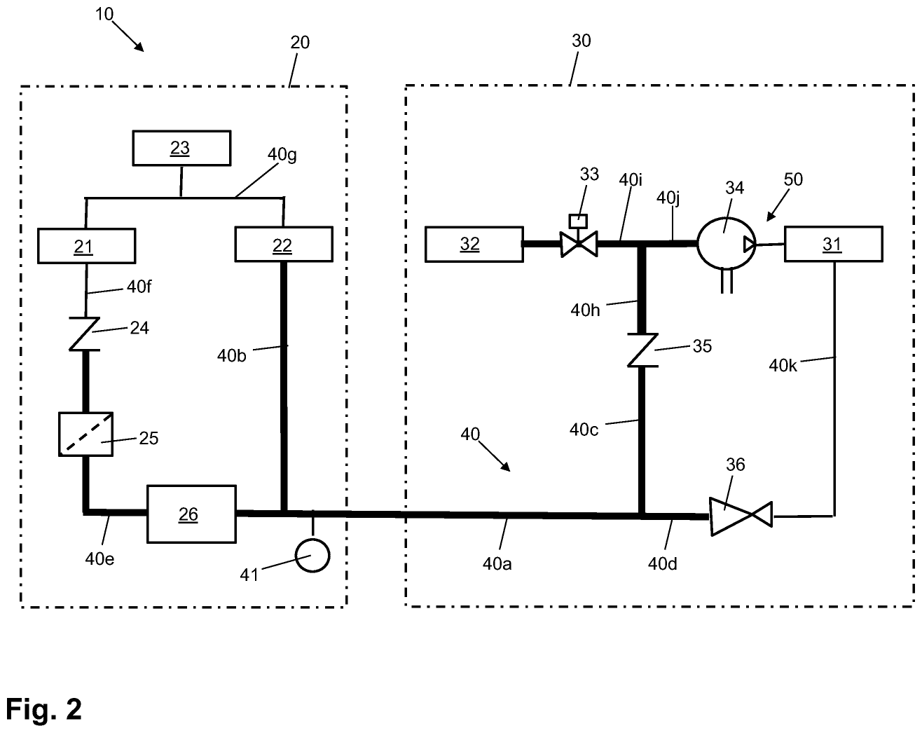

FIGS. 1 to 4 show an energy system 10 which is used as a house energy system. In FIG. 1, the basic structure of the energy system 10 is first described. The method for pressure adaption according to the invention is performed in the energy system 10. The process flow in different modes of operation of the energy system 10 is explained with reference to FIGS. 2 to 4.

As can be seen from FIG. 1, energy system 10 initially comprises a first subsystem 20 which is configured as an inner system. That is, the first subsystem 20 is provided inside the house. In addition, the energy system 10 comprises a second subsystem 30 in the form of an outer system. That is, the second subsystem 30 is external to the house.

The first subsystem 20 comprises a first energy source device 21, which is an electrolysis device for producing hydrogen. In addition, the first subsystem 20 comprises a first energy sink device 22, which is a fuel cell device. The second sub-system 30 comprises a second energy source device 31, which is a high-pressure storage device. The hydrogen produced in the electrolysis device is stored in the high-pressure storage device at up to 700 bar. In addition, the second subsystem 30 comprises a second energy sink device 32 in the form of a medium-pressure storage device, in which the hydrogen produced is temporarily stored at pressures between 20 and 60 bar, before it gets finally stored by the high-pressure storage device.

The individual components of the energy system 10 are connected to one another via a connecting line device 40, which consists of a number of different line sections 40a to 40k. A first number of line sections 40a to 40e are designed as so-called bidirectional line sections. That means that these line sections 40a to 40e get flown through in both directions during operation of the energy system 10.

For purging the first energy source device 21 and/or the first energy sink device 22, a purging system 32 with a purge chamber is provided, which is connected via line section 40g to the two components mentioned before.

The hydrogen produced in the first energy source device 21 by means of electrolysis leaves the first energy source device 21 via a line section 40f, which passes over in bidirectional line section 40e. In both line sections 40f and 40e, in the flow direction of the produced hydrogen, a check valve device 24 and subsequently a filter device 25 and a dryer device 26 are provided, in which the produced hydrogen gets filtered and dried. The filter device 25 and the dryer device 26 can alternatively also be located in the second subsystem 30.

From the dryer device 26, the produced hydrogen produced flows via the bidirectional line sections 40a and 40c to a further check valve device 35, which marks an end of line section 40c. From there, via line sections 40h and 40i, the produced hydrogen flows into the second energy sink device 32 functioning as a medium-pressure storage device, which is connected to a further line section 40j via a valve device 33, which in particular is provided as a shut-off valve, for example in the form of a solenoid valve. In line section 40j, which ends in the second energy source device 31, which is formed as a high-pressure storage device, upstream of the second energy source device 31 a compressor device 34, in particular in the form of a piston compressor, is provided. The generated hydrogen is stored in the second energy source device 31 by actuating the compressor device 34. Further, this compressor device 34, together with the second energy source device 31, functions as a pressure adaption device 50, which comes to use during the performance of the method according to the invention. The hydrogen intermediately stored in the second energy sink device 34 gets stored into the second energy source device 32 upon actuation of the compressor device 34.

This production process of the hydrogen up to its storage in the second energy source device 31 represents a first mode of operation of the energy system 10. In this first mode of operation of the energy system 10, bidirectional line sections 40a to 40e of the connecting line device 40 have a pressure of 20 to 60 bar. Such a pressure also prevails in the second energy sink device 32. By means of the compressor device 34, the hydrogen which is withdrawn from the second energy sink device 32, which is an intermediary storage device, is compressed to such an extent that it can be stored at pressures of up to 700 bar in the second energy source device 31, which is a high-pressure storage device.

The hydrogen stored in the second energy source device 31 is used for the operation of the first energy sink device 22 in the form of the fuel cell device. The operation of the fuel cell device takes place in the second mode of operation of the energy system 10. However, the fuel cell device can only operate at pressures of less than 20 bar. In the second mode of operation of the energy system 10, the hydrogen is removed from the second energy source device 22 via a line section 40, gets expanded via an expansion device 36 in the form of a pressure reducer and gets transported via a bidirectional 40a, from where it enters the first energy sink device 22 designed as a fuel cell device via bidirectional line section 40b. The reduction of the pressure in bidirectional line sections 40a to 40e of the connecting line device 40 to a value of less than 20 bar is achieved by means of pressure adaption device 50. To measure the pressure, at least one pressure measuring device 41, for example in the form of a pressure sensor, is provided.

The energy system 10 illustrated in FIGS. 1 to 4 represents a partial area of an overall house energy system, which is a multi-hybrid house energy storage system that is electrically autonomous and that is completely based on renewable energies.

The multi-hybrid house energy storage system makes it possible that the electrical energy generated by a photovoltaic (PV) system, a small wind power plant or the like is distributed as required to the entire year. The system acts as an island system independent of the electrical network. Rather, the system is to ensure the electrical autarchy of the house, so that no electrical energy has to be drawn from the power grid over the entire year.

The primary task of the house power system is to make available the recovered electrical energy from photovoltaic (PV) modules or the like to the consumer in the household. Secondary, electrical energy excesses can be temporarily stored in a battery short-term storage device at times of low load or high irradiation. Tertiary, the electrical energy can be medium to long-term stored in the hydrogen long-term storage as gaseous hydrogen for times of low irradiation such as night, winter or the like, and can be needs-based made available again at any time by means of a fuel cell.

Besides to energy-related tasks, the system also functions as a controlled living room ventilation by means of a built-in ventilation device.

The hydrogen produced in the electrolysis device flows via the hydrogen line into the outwardly provided pressure storage system.

In the event of a lack of or insufficient PV energy, energy is supplied from the battery to cover the consumer load. If the energy stored in the short-term storage device is not sufficient, the fuel cell device can satisfy the additional electrical energy requirement. In the fuel cell operation, the hydrogen flows from the pressure storage system to the fuel cell device via the hydrogen line.

The simultaneous operation of the fuel line device and the electrolysis device is excluded. The entire system is operated centrally via an energy manager with predictive energy management.

In principle, the second subsystem is provided for operation in the outer region, but can also be erected and operated within a special region of the house under certain conditions.

The procedure of the method according to the invention is now explained with reference to FIGS. 2 to 4.

In FIG. 2, a first mode of operation of the energy system 10 is illustrated. When the hydrogen is generated in the first energy source device 21, which is an electrolysis device, the line sections marked in bold of the connecting line device 40 as well as the second energy sink device 32 in the form of the medium-pressure storage device have a pressure level of 20 to 60 bar. However, the pressure reducer in the first energy sink device 22 in the form of the fuel cell device can regulate pressures up to less than 20 bar only. Therefore, no fuel cell operation is possible at this line pressure.

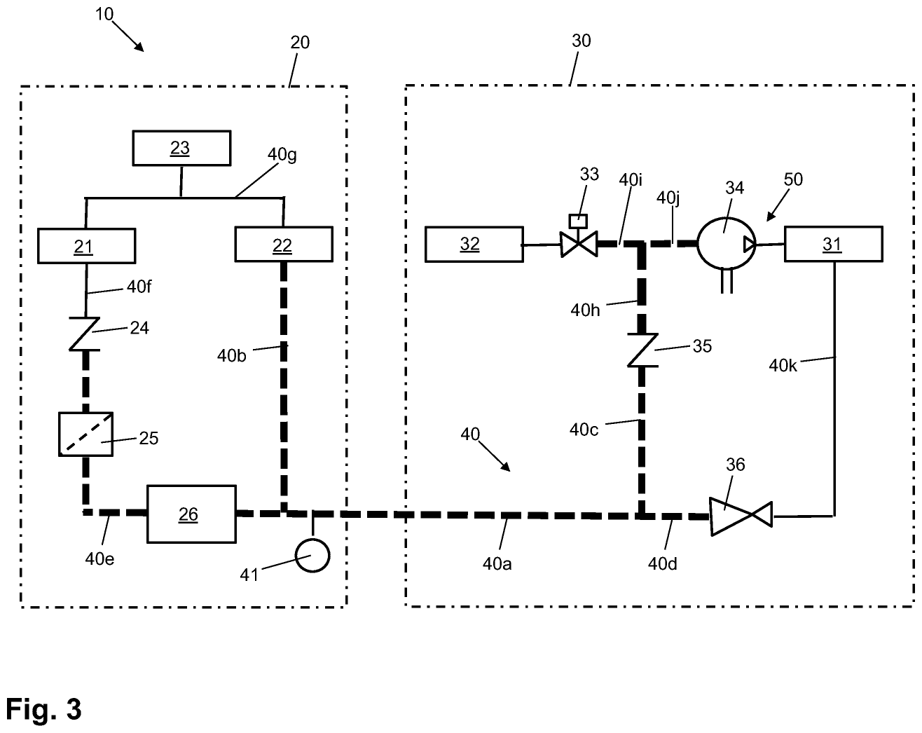

FIG. 3 depicts the transition from the first mode of operation of the energy system 10 to its second mode of operation. By closing the valve device 33, as a result of which the path into the second energy sink device 32 is terminated. By closing the valve device 33, the second energy sink device is decoupled from the connecting line device 40 at this time of the method, so that the hydrogen with the pressure of 20 to 60 bar prevailing in the second energy sink device 31 can remain therein at this pressure. Due to a compression by means of the compressor device 34 in the second energy source device 31 in the form of the high-pressure storage device, the pressure of the reduced volume gets reduced in those line sections of the connecting line device 40, which are marked in bold and in dashed lines. The pressure reduction is accelerated by the reduced volume. When the fuel cell operating pressure of less than 20 bar is reached in the line sections of the connecting line device 40 marked in bold and dashed lines, the pressure reduction is completed.

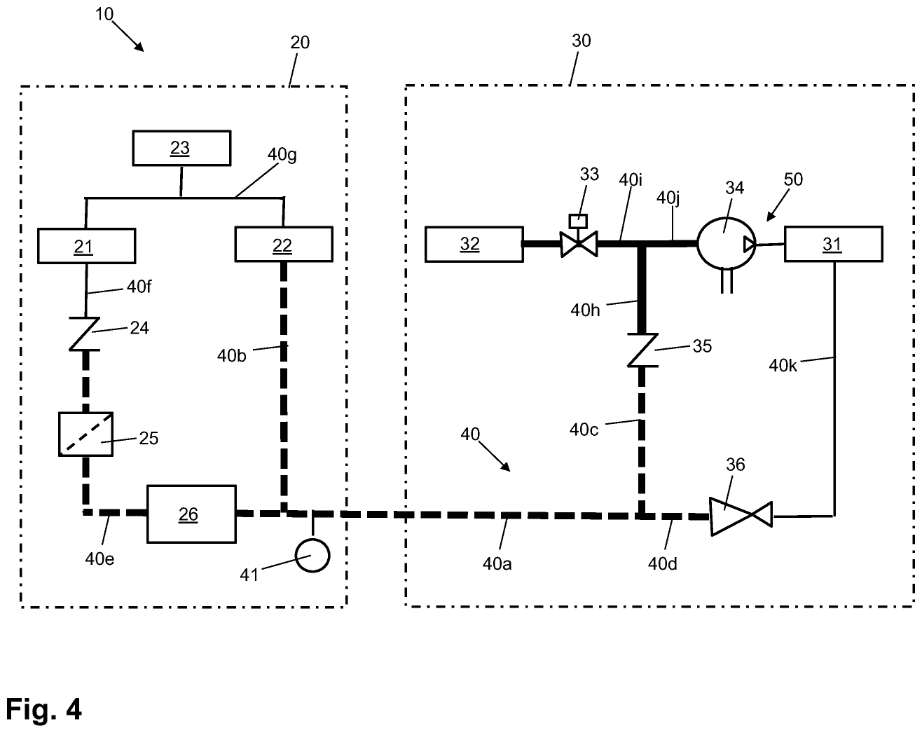

Finally, FIG. 4 shows the second mode of operation of the energy system 10. By opening the valve device 33 and switching off the compressor device 34, the initial state is restored. The pressure of the second energy sink device 32 in the form of the medium-pressure storage device is now on up to the check valve device 35 and the compressor device 34, which is illustrated by the bold-marked line sections of the connecting line device 40. The bidirectional line sections of the connecting line device 40 continue to have the reduced fuel cell operating pressure of less than 20 bar up to the first energy sink device 22 in the form of the fuel cell device, which is illustrated by the bold and dashed marked line sections of the connecting line device 40. The fuel cell device can now get started.

### LIST OF REFERENCE NUMERALS

10 Energy system (house energy system)
20 First subsystem (inner system)
21 First energy source device (electrolysis device)
22 First energy sink device (fuel cell device)
23 Purging device (purge chamber)
24 Check valve device
25 Filter device
26 Dryer device
30 Second subsystem (outer system)
31 Second energy source device (high-pressure storage device)
32 Second energy sink device (medium-pressure storage device)
33 Valve device
34 Compressor device
35 Check valve device
36 Expansion device (pressure reducer)
40 Connecting line device
40a to 40e Bidirectional line section
40f to 40k Line section
41 Pressure measuring device
50 Pressure adaption device

1. An energy system (10), in particular a house energy system, comprising a first energy source device (21), a first energy source device (22), a second energy source device (31), and a connecting line device (40), by means of which the first energy source device (21) to the second energy source device (31) and the second energy source device (31) to first energy sink device (21) are connected to each other, characterized in that at least individual sections of the connecting line device (40) are configured as bidirectional line sections (40a to 40e), via which a flow takes place in both directions during operation of the energy system, and in that the connecting line device (40) is connected to at least one pressure adaptation device (50), which is provided in such a way that it is capable to set a direction-dependent pressure level in the bidirectional line sections (40a to 40e) of the connecting line device (40).

2. The energy system according to claim 1, characterized in that the energy system (10) comprises a second energy sink device (32) which is connected via a valve device (33) to the connecting line device (40).

3. The energy system according to claim 1, characterized in that the first energy source device (21) is configured as an electrolysis device, in particular for producing hydrogen, and/or in that the first energy sink device (22) is configured as a fuel cell device and/or in that the second energy source device (31) is configured as high-pressure storage device, in particular for storing hydrogen, and/or in that the second energy sink device (32) is configured as a medium-pressure storage device, in particular for intermediary storing hydrogen.

4. The energy system according to claim 1, characterized in that the pressure adaptation device (50) is configured as a device for reducing pressure in the bidirectional line sections (40a to 40e) of the connecting line device (40).

5. The energy system according to claim 1, characterized in that the pressure adaptation device (50) comprises a compressor device (34) which is provided in the connecting line device (40) and which is connected to a storage device, in particular to the second energy storage device (31), and in that the compressor device (34) is, in particular, at the same time that compressor device (34) which is used to load the second energy source device (31).

6. The energy system according to claim 1, characterized in that the pressure adaptation device (50) is configured as an additional expansion volume which is connected via a valve device to the connecting line device (40), and in that the additional expansion volume is preferably greater than the volume of the connecting line device (40), in particular as the volume of the bidirectional line sections (40a to 40e) of the connecting line device (40).

7. The energy system according to claim 1, characterized in that the energy system comprises a purging device (23) which is provided in such a way that it is capable of purging the first energy source device (21) and/or the first energy sink device (22), and in that the purging device (23) functions as the pressure adaptation device (50) and is connected to the connecting line device (40), in particular to the bidirectional line sections (40a to 40e) of the connecting line device (40), via a valve device.

8. The energy system according to claim 1, characterized in that at least one check valve device (24, 35) is arranged in the connecting line device (40), and in that the check valve device (24, 35) marks one end of a bidirectional line section.

9. The energy system according to claim 1, characterized in that at least one pressure measuring device (41) is assigned to the connecting line device (40), in particular to at least one bidirectional line section (40a to 40e) of the connecting line device (40).

10. A method of adapting the line pressure in a connecting line device of an energy system, in particular of a house energy system, wherein the energy system comprises a first energy source device, which is connected to a second energy source device via the connecting line device, and wherein the energy system comprises a first energy sink device, which is connected via the connecting line device to the second energy source device, characterized by the following steps:
a) in a first mode of operation of the energy system, an energy provided by the first energy source device is transported at a first pressure via the connecting line device to the second energy source device and is stored there, wherein at least individual sections of the connecting line device are configured as bidirectional line sections, via which a flow takes place in both directions during operation of the energy system;
b) in at least one second mode of operation of the energy system, energy provided by the second energy source device is supplied with a second pressure, which is different from the first pressure, via the bidirectional line sections of the connecting line device to the first energy sink device;
c) depending on the mode of operation of the energy system, a direction-dependent pressure level in the bidirectional line sections of the connecting line device is set by means of a pressure adaptation device, which is connected to the connecting line device.

11. The method according to claim 10, characterized in that the method is performed in an energy system comprising: a first energy source device (21), a first energy source device (22), a second energy source device (31), and a connecting line device (40), by means of which the first energy source device (21) to the second energy source device (31) and the second energy source device (31) to first energy sink device (21) are connected to each other, characterized in that at least individual sections of the connecting line device (40) are configured as bidirectional line sections (40a to 40e), via which a flow takes place in both directions during operation of the energy system, and in that the connecting line device (40) is connected to at least one pressure adaptation device (50), which is provided in such a way that it is capable to set a direction-dependent pressure level in the bidirectional line sections (40a to 40e) of the connecting line device (40).

12. The method according to claim 10, characterized in that in the case of changing from the first mode of operation of the energy system to the second mode of operation of the energy system, the line pressure prevailing in the first mode of operation in the form of the first pressure in the bidirectional line sections is reduced to the line pressure in the form of the second pressure prevailing in the second mode of operation by means the pressure adaptation device, wherein in particular the volume being present at least in the bidirectional sections of the connecting line device is reduced by means of the pressure adaptation device.

13. The method according to claim 10, in which the energy system comprises a second energy sink device which is connected to the connecting line device via a valve device, characterized in that, in the first mode of operation of the energy system, the energy provided by the first energy source device with the first pressure is transported via the connecting line device to the second energy sink device and is intermediately stored there, and in that subsequently the energy intermediately stored in the second energy sink device is transported from there to the second energy source device and stored there.

14. The method according to claim 10, in which a compressor device is arranged in the connecting line device, characterized in that, in the first mode of operation of the energy system, energy which is provided by the first energy source device or energy that is intermediately stored with the first pressure is transported via the connecting line device to the compressor device and is stored via said compressor device in the second energy source device.

15. The method according to claim 14, characterized in that the compressor device functions as the pressure adaptation device, in that, depending on the mode of operation of the energy system, a direction-dependent pressure level is set in the bidirectional line sections of the connecting line device by means of the compressor device, and in that preferably in the event of a change from the first mode of operation of the energy system to the second mode of operation of the energy system, via the compressor device the line pressure prevailing in the first mode of operation in form of the first pressure in the bidirectional line sections is reduced to the line pressure prevailing in the second mode of operation in form of the second pressure in the bidirectional line sections, in that in particular volume being present in the connecting line device, is stored via the compressor device into the second energy source device until the second pressure is achieved in the bidirectional line sections of the connecting line device.
